(19) United States
(12) Patent Application Publication
(10) Pub. No.: US 2010/0332019 A1
(43) Pub. Date: Dec. 30, 2010

(54) LevPro safety system

(75) Inventor: Steven C. Shaw, Cocoa, FL (US)

Correspondence Address: Levitating Productions, Inc., 5690 Falcon Blvd., Cocoa, FL, 32927, US

(73) Assignee: LevPro Systems, Inc., Cocoa, FL (US)

(21) Appl. No.: 12/802,110

(22) Filed: May 28, 2010

Related U.S. Application Data
(60) Provisional application No. 61/217,497, filed on Jun. 1, 2009.

(51) Int. Cl. B66C 13/18; G06F 19/00

(52) U.S. Cl. 700/213

(57) ABSTRACT

A load monitoring system to provide the user with pertinent information necessary to plan, install and monitor load and tension measurements during over-head lifting practices. The process includes the measurement instrument with a power supply and data converter with a means of broadcasting data packets to a computer readable medium containing software which interprets the computer-implemented information in a presentable format. The process provides a means of planning for an over-head lifting practice and real time monitoring and recording of the over-head lifting practice. The process provides users the information to accurately install the over-head lifting device or the means of attachment to the architectural structure. Thus, saving time and resources in the planning and installation process, while monitoring real time loads being exerted onto the architectural structure creating a safer over-head lifting environment.

### BACKGROUND OF THE INVENTION

The present invention was conceived in direct relation to the common unknowns occurring in the standard over-head lifting practices observed in the entertainment industry with regards to temporary and permanent installations. Concert tours, corporate meetings, award presentations, etc. utilizing chain hoists to lift trusses, audio cabinets, video walls, or other production elements have long relied on the head rigger (who may or may not consult an engineer) and manufacturer specifications of equipment weight to establish the estimated loads being lifted by the chain hoists through tedious mathematics. The estimated loads are presumed to be correct if the structure being lifted is level at all points; however, the phenomenon called indeterminate structure is not considered when these over-head lifting practices are being performed. In statics, a structure is statically indeterminate when the static equilibrium equations are insufficient for determining the internal forces and reactions on that structure.

To solve the insufficiencies of the equilibrium equations, head riggers have looked towards industrial applications involving over-head lifting practices and the use of load cells to determine actual loads being present on each individual chain hoist or static load attachment. A wide range of products are available for this type of monitoring; however, the short comings of these products have limited the wide spread use and standardization of safer over-head lifting practices as it relates to load cells, indeterminate structure, and the knowledge and documentation of actual loads being monitored on such temporary and permanent installations within the entertainment industry. Limitations include loss of headroom due to the size of load cells used in the past, some measuring up to 18″ of additional height required. Other limitations include but not limited to fragility, frequency interference, reliability, accuracy, tolerance to weather, ease of use and quantities in use simultaneously.

The present system has been developed to address many of these issues that have been encountered through the years by developing a system with the entertainment industry and industry accepted rigging and over-head lifting practices in mind. This invention allows the user to plan, install, and monitor the activities of over-head lifting and provide the necessary information to analyze and implement safer practices and prevent indeterminate structure and unintentional overloading of chain hoists and/or architectural structures causing damages to structures and injury or possible death to workers or attendees.

### SUMMARY OF THE INVENTION

The LevPro Safety System is comprised of the following components: Safety Shackle, a cable assembly, a repeater, and monitoring software.

The LevPro Safety Shackle comprises the following components. The use of the clevis of a standard anchor safety shackle, in particular a clevis manufactured by the Crosby Group or Columbus McKinnon (prior approval granted regarding the use of the clevis by both manufacturers). The clevis pin is replaced by the specially designed strain gage to accurately measure the force exerted on the pin during an over-head lifting practice. The strain gage is based on previous patents regarding measuring deflection of material and translating the deflection in to an electrical output to be later amplified for transmission. The strain gage is manufactured using 17-4 PH heat treated stainless steel for its properties of extraordinary duty cycles and resilience to harsh environments that it may encounter within the industry. The shackle assembly is then connected to a power and communication unit (LevPro Repeater Unit) utilizing a RJ-45 cable assembly with IP-67 rated industrial bayonet connectors for use indoors and outdoors. The LevPro Repeater Unit provides the shackle assembly with the excitation necessary to activate the Wheatstone bridge circuit used in the strain gage and receives the signal from the circuit. The repeater thus prepares the data packet received from the strain gage and broadcasts the data packet upon request from the user to the computer readable device comprising software for the user to analyze and monitor the forces exerted on the strain gages.

The LevPro Safety System is a unique risk reduction system designed for the rigors of the entertainment industry. The system provides information to the end-user to make critical decisions related to the safe installation and operation of temporary and permanent rigging systems.

### BRIEF DESCRIPTION OF THE DRAWINGS

In order to more fully understand the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a representational drawing of the shackle assembly with performance specifications of the strain gage.

FIG. 2 is a representational drawing of the AC power cable used in the repeater.

FIG. 3 is a representational drawing of the DC power cable used in the repeater.

FIG. 4 is a representational drawing of the ribbon cable used in the repeater.

FIG. 5 is a representational drawing of the component layout inside the repeater.

FIG. 6 is a representational drawing of the component layout on the front and rear panel of the repeater.

FIG. 7 is a representational drawing of sheet 1 of 2 of the motherboard of the repeater.

FIG. 8 is a representational drawing of sheet 2 of 2 of the motherboard of the repeater.

FIG. 9 is a representational list of the components to assemble the front and rear panels of the repeater.

FIG. 10 is a representational list and instructions of the components to assemble the repeater.

FIG. 11 is a representational drawing of the preferred cable assembly to connect the strain gage to the repeater.

FIG. 12 is a representational graphic display of software used to interface the system.

### DETAILED DESCRIPTION OF THE PREFERRED EMBODIMENT

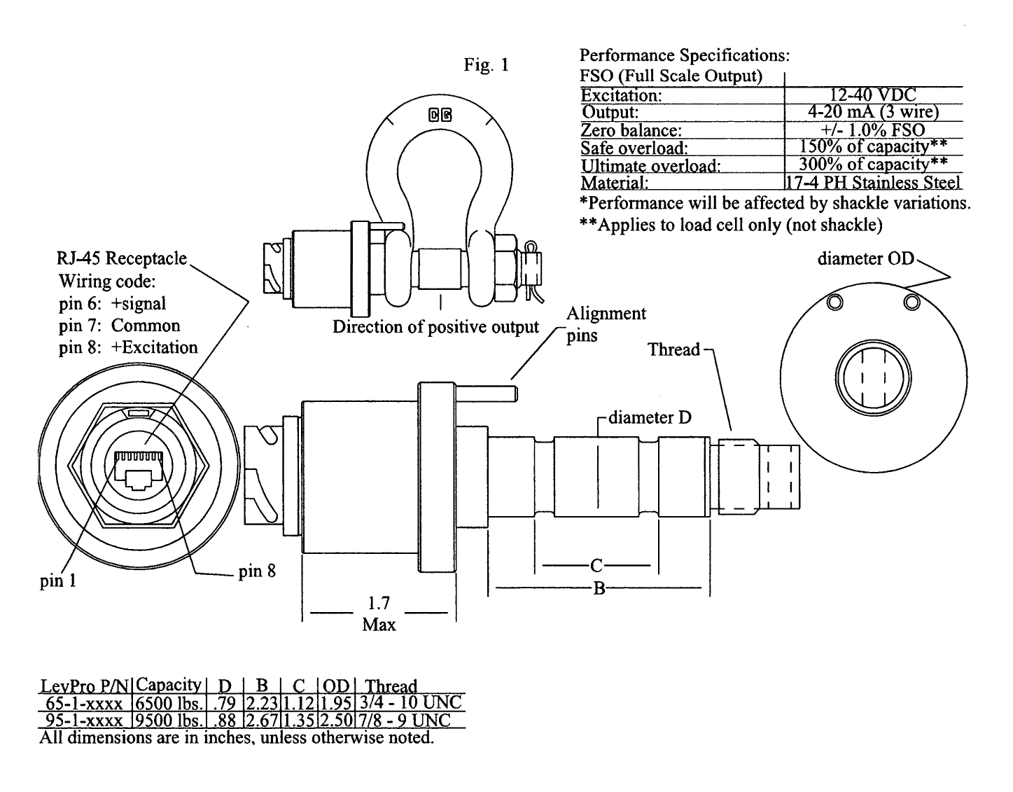

FIG. 1 is a representational drawing of the complete shackle assembly with performance specifications of the strain gage. As noted the full shackle assembly comprises the clevis, nut, lynch pin, and strain gage, as shown in the top left-hand corner of the FIG. 1. The complete assembly is designed to measure tension force, as illustrated with the directional note indicating a positive output. When the shackle assembly is in compression, the output will display as a negative reading and an under-loading situation has occurred. The preferred clevis to be used in the complete assembly is noted and documented as being either a Crosby Group or a Columbus McKinnon Safety Anchor Shackle at the desired size, currently but not limited to a ⅝″ and a ¾″ Clevis. In the lower left-hand corner of the representational drawing is the Molex RJ-45 Receptacle with wiring diagram of the 3-wire strain gage. Also noted, is the direction from which the number one terminal starts and finishes with the number 8 terminal for proper wiring throughout the system. In the lower center of the representational drawing, the side view of the actual strain gage including the representational measurements required for each corresponding clevis size to be used. The alignment pins are necessary for proper readings of the strain gage, since the Wheatstone bridge is in alignment for tensional readings and proper alignment on axis is critical for accurate readings. In the upper right-hand corner, the performance specifications at Full Scale Output are stated. The required excitation for the strain gage shall be between 12-40 Volts DC. The output is amplified at the strain gage to be a 4-20 mA current loop. The linearity, hysteresis & repeatability combined is +/−1.0% at Full Scale Output. The calibration for zero balance is set within the same +/−1.0% at Full Scale Output. The operating temperature for the strain gage is −50 to +250 degrees Fahrenheit or −46 to 121 degrees Celsius. The compensated temperature range is +60 to +160 degrees Fahrenheit or +15 to +71 degrees Celsius. Tested thermal effects as tested on zero resulted in +/−0.01% at Full Scale Output per degree Fahrenheit and on the span resulting in +/−0.01% Reading per degree Fahrenheit. The safe overload is stated at 150% of noted capacity with an ultimate overload of 300% of noted capacity. The strain gage is manufactured with 17-4 PH Stainless Steel.

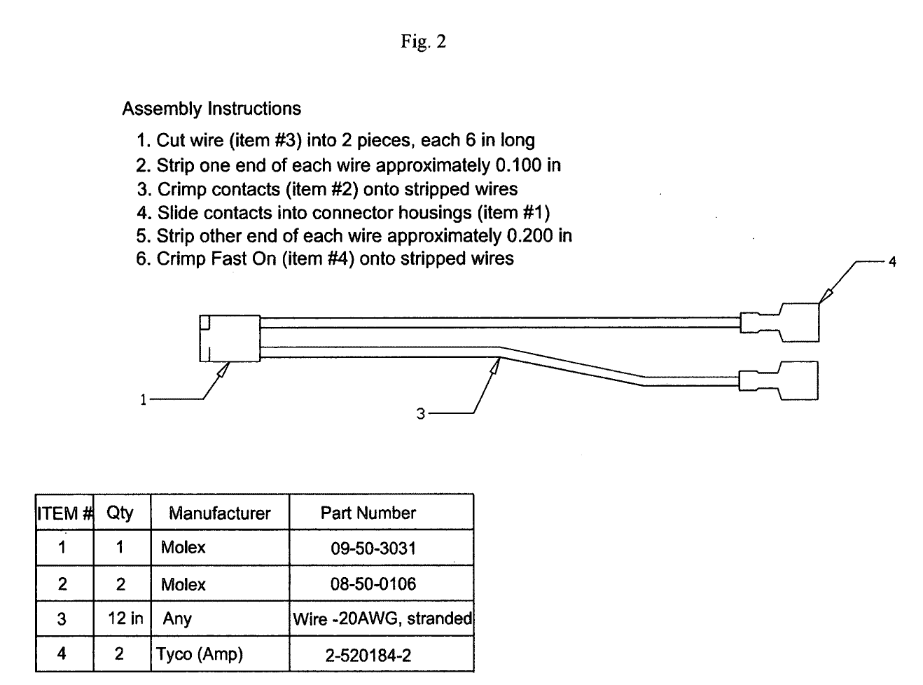

FIG. 2 is a representational drawing of the AC Power cable found inside the repeater box. The AC Power cable is set in-line with the universal power module attached to the rear enclosure to the power transformer. In the upper left-hand corner of the representational drawing comprise the recommended assembly instructions for this cable. In the lower left-hand corner of the representational drawing comprise the suggested parts list to manufacture the AC Power cable.

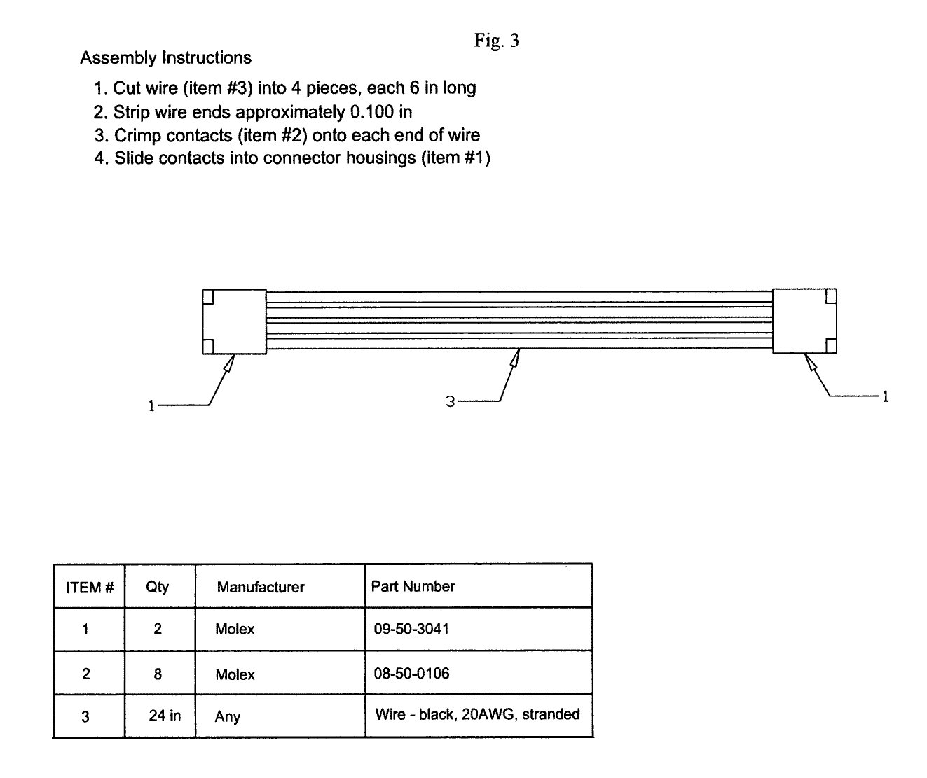

FIG. 3 is a representational drawing of the DC Power cable found inside the repeater box. The DC Power cable is set in-line with the power transformer to the motherboard. In the upper left-hand corner of the representational drawing comprise the recommended assembly instructions for this cable. In the lower left-hand corner of the representational drawing comprise the suggested parts list to manufacture the DC Power cable.

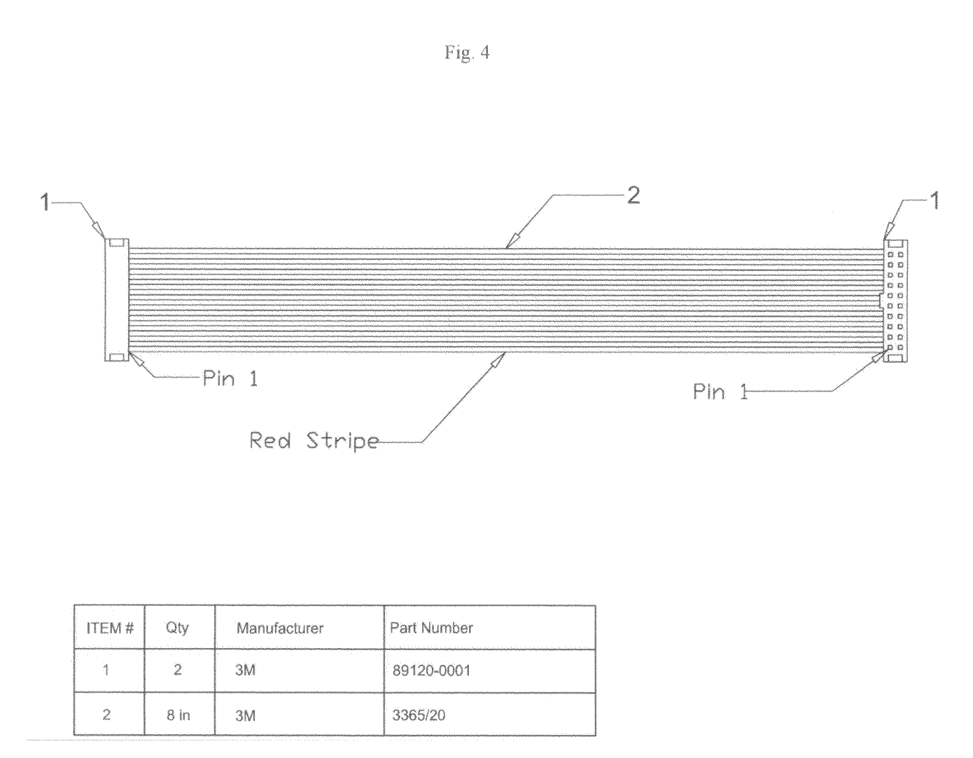

FIG. 4 is a representational drawing of the Ribbon cable found inside the repeater box. The Ribbon cable is set in-line with the motherboard to the front PCB. In the lower left-hand corner of the representational drawing comprise the suggested parts list to manufacture the Ribbon cable.

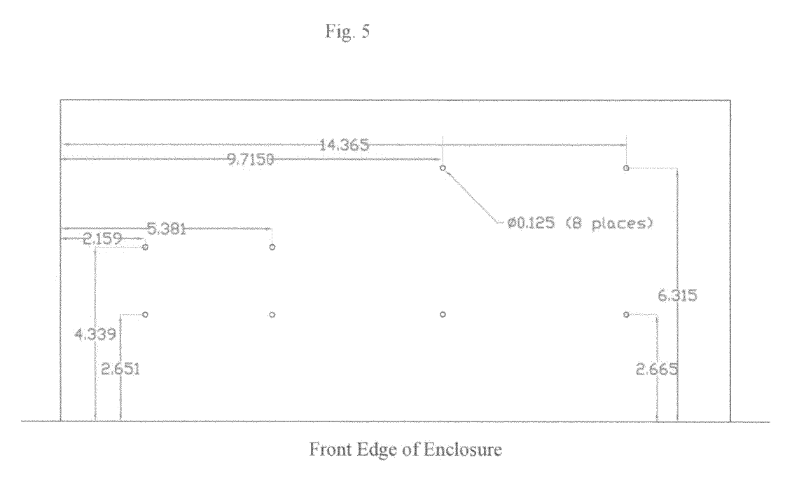

FIG. 5 is a representational drawing of the placement of the PCB components comprised within the Enclosure Chassis. The area marked out to the left of center is the recommended location for the DC Power Transformer. All measurements are in inches and are representational to the manufactured product. The area marked out to the right of center is the recommended location for the motherboard.

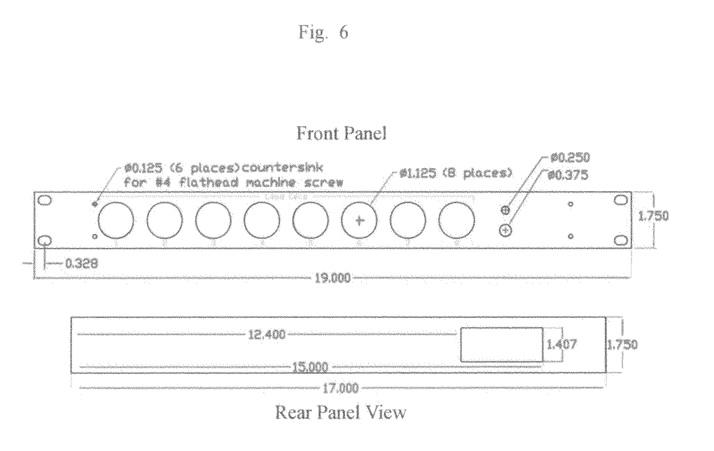

FIG. 6 is a representational drawing of the Front Panel and Rear Panel of the repeater box. In FIG. 6, the drawing comprises the location of cutouts for mounting hardware to the far left and right. The drawing further comprises the recommended location of the 8 connectors linking the repeater box to the strain gages. The drawing further comprises the recommended location of the external antennae and the “wink” LED. The lower section of the drawing comprises the recommended location of the AC Power Module. All measurements are in Inches and are representational to the manufactured product.

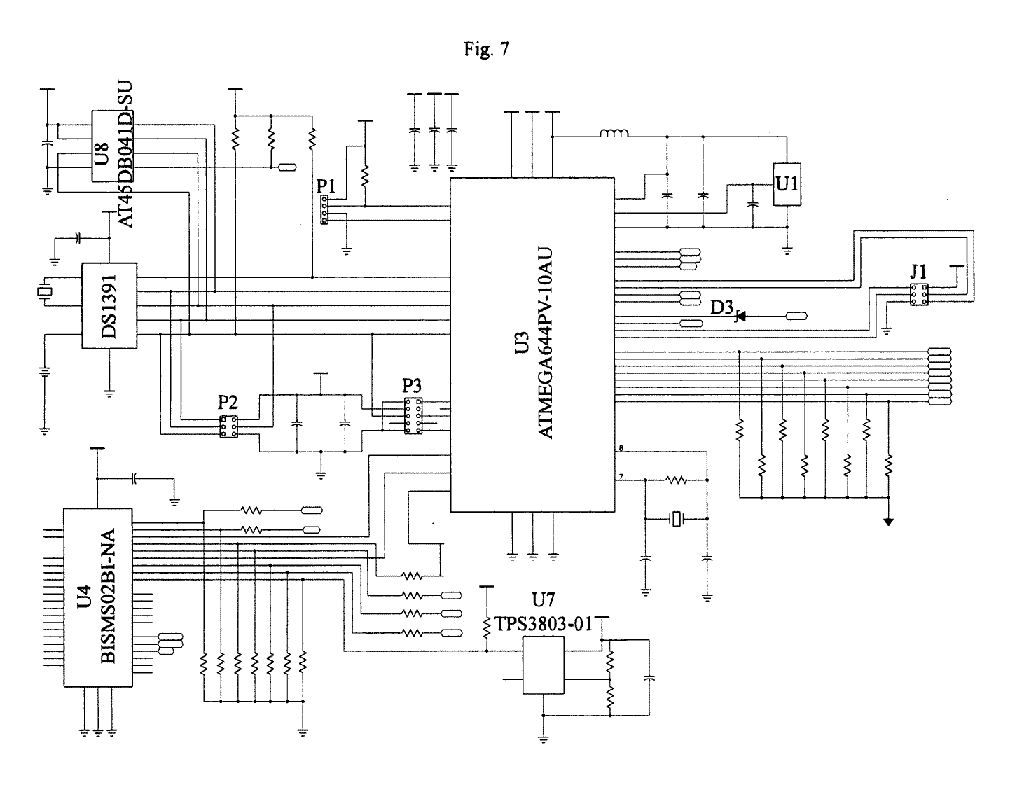

FIG. 7 is a representational circuit schematic of the motherboard, wherein comprises the AC input module with a supply rating of 85-264 Volts, 50-60 Hertz. It is recommended to be consistent with the manufactured product, the AC input module further comprises a power switch, fuse, and IEC plug jack. The represented circuit schematic of the motherboard further comprises a power supply, which transforms the delivered AC current and establishes a DC power source for the remaining components of the repeater. The represented circuit schematic of the motherboard further comprises the following components: AVR microprocessor, Connect ME, Real time clock, Bluetooth module, and 4-20 mA interface. The AVR microprocessor comprises the firmware which states fuse settings, voltage settings, sensor behaviors and the set of operational parameters for bi-directional communication with the computer readable medium comprising the software. The Connect ME module comprises a bi-directional communication interface with the output jack. The output jack may be connected directly to a computer readable medium comprising the software. All bi-directional communications comprises a time stamp as produced by the time stamp clock present on the representational circuit schematic of the motherboard. The Bluetooth module comprises a bi-directional communication broadcast with the external antennae. The bi-directional communication broadcast connects to a computer readable medium comprising the software. The 4-20 mA interface comprises the necessary analogue to digital converter for further processing through the system.

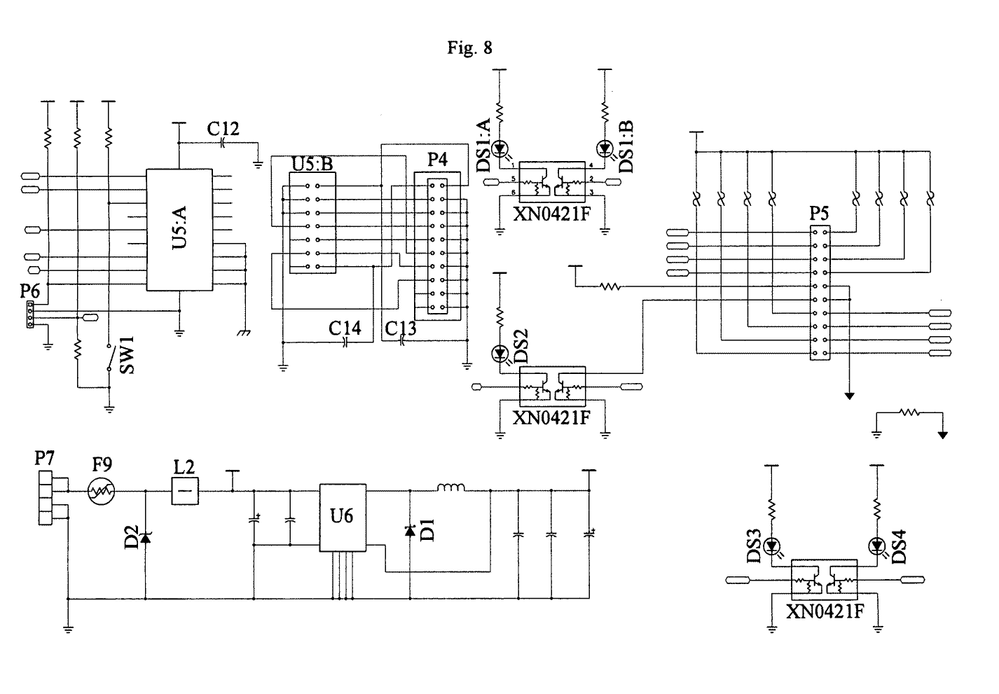

FIG. 8 Further comprises the remaining representational circuit schematic of the motherboard, including, but not limited to the led indicators on the motherboard.

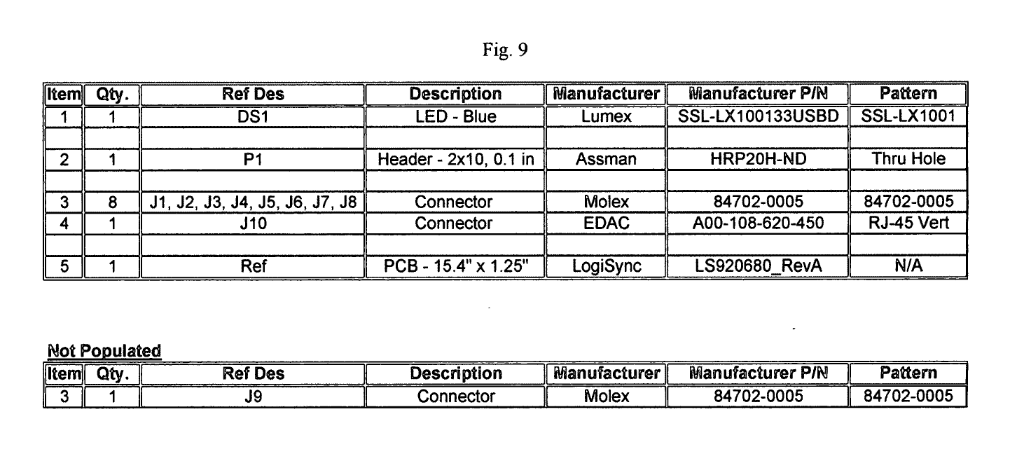

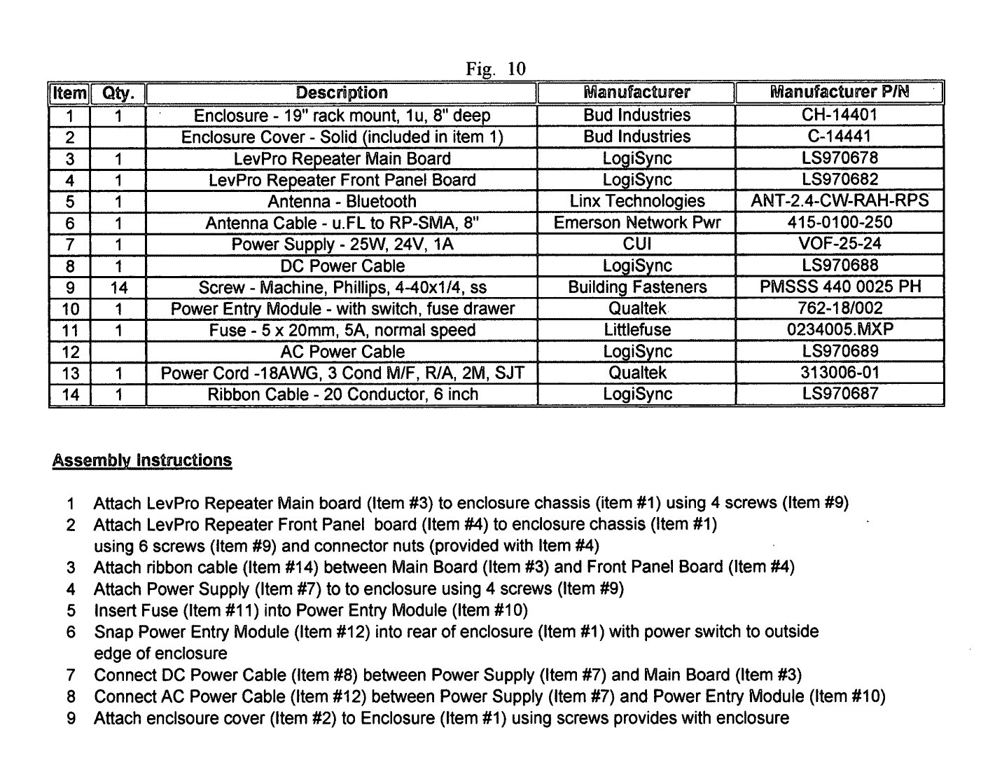

FIG. 9 is a representational list of components recommended for the manufacture and assembly of the front PCB module. The front PCB module comprises the “wink” LED, the strain gage receptacles, the output receptacle and the currently not populated external output receptacle.

FIG. 10 is a representational list and compiled set of instructions for assembly of the manufactured product. The stated DC Power cable (FIG. 3), AC Power cable (FIG. 2), and Ribbon cable (FIG. 4) are detailed in extent above and are identified on said list and further instructed of the final placement within the repeater assembly.

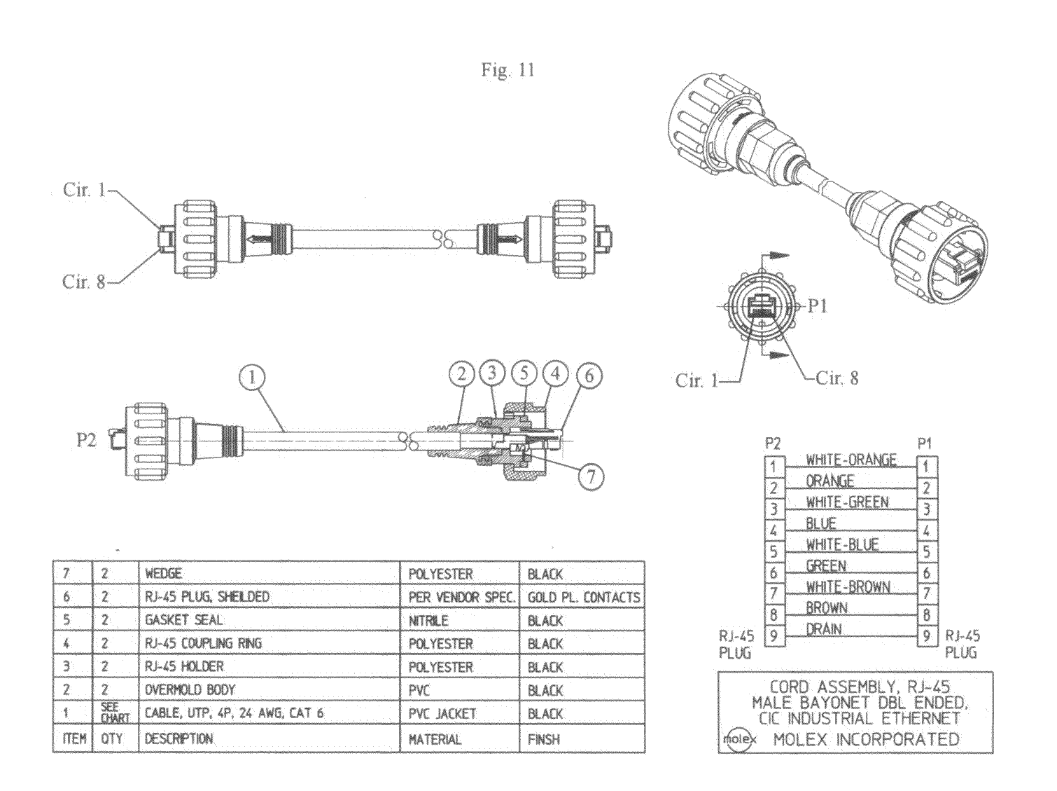

FIG. 11 is a representational drawing of the recommended RJ-45 male industrial bayonet cable assembly. The cable assembly comprises the Molex RJ-45 male industrial bayonet connector (manufactured and field connector represented on drawing) and a typical 4 pair, 24 AWG rated cable of any length. FIG. 11 further comprises in the lower right-hand corner, the recommended wire diagram of said cable assembly for the proper functionality of the system.

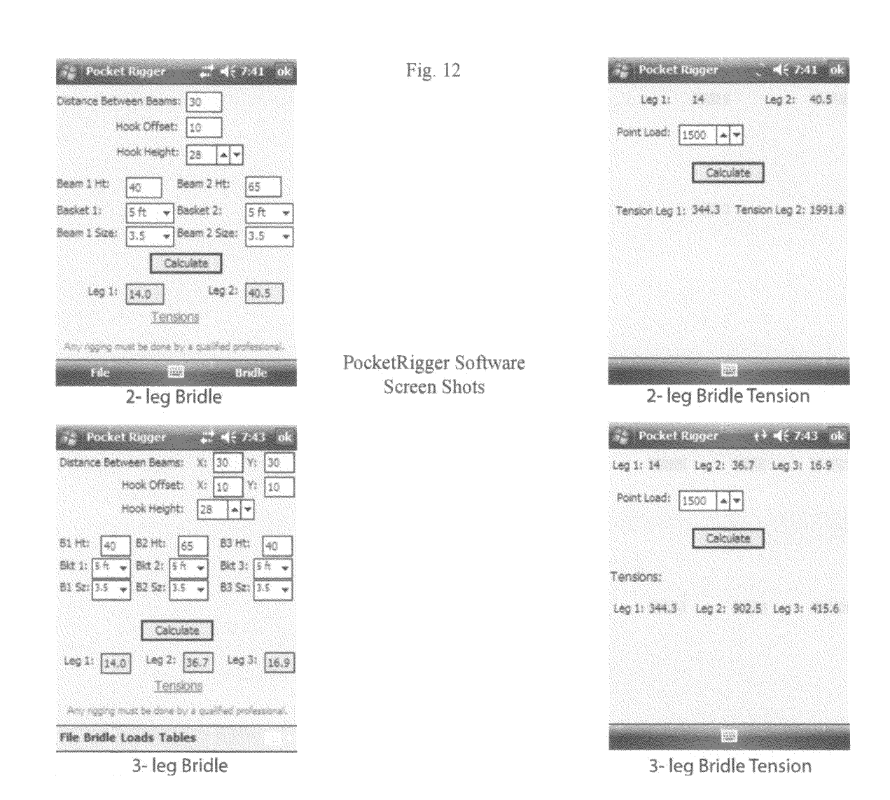

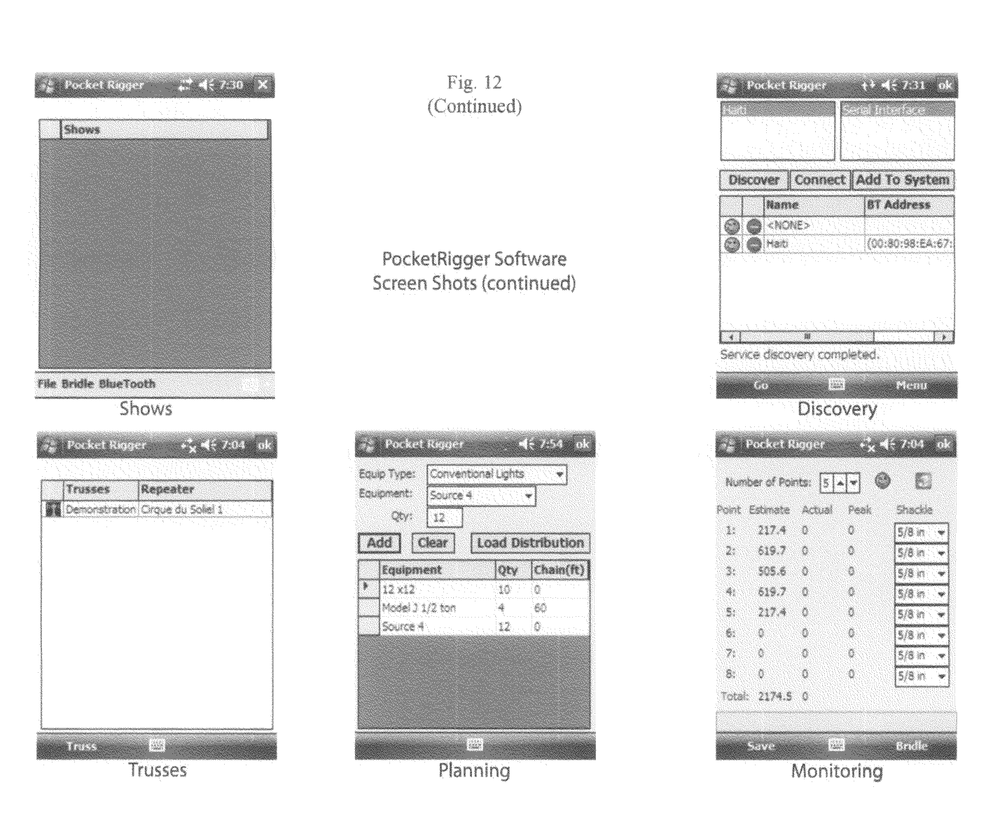

FIG. 12 is the representational screen shots of the computer readable medium software. In the first shot denoted as 2-leg Bridle, the software enables a computer-implemented series of inputs to be calculated with the encoded computer program, allowing the user to receive the correct resultant. The screen shot representational of the computer-implemented software activity entitled 2-leg Bridle Tension appears upon selection of “tensions” at the lower center of the page entitled 2-leg Bridle. This selection allows the user to input a point load or weigh to be exerted on the Bridle and the tension will be calculated. In the third screen shot representational of the computer-implemented software activity denoted as 3-leg Bridle, the software enables a computer-implemented series of inputs to be calculated with the encoded computer program, allowing the user to receive the correct resultant. The screen shot representational of the computer-implemented software activity entitled 3-leg Bridle Tension appears upon selection of “tensions” at the lower center of the page entitled 3-leg Bridle. This selection allows the user to input a point load or weigh to be exerted on the Bridle and the tension will be calculated. In the lower left-hand corner, the screen shot entitled shows is represented. This representational page of the computer readable medium software is the active menu page and all access to further pages is accomplished from this area. In the next screen shot to the right of shows, is the discovery screen shot. This screen shot is representational of the computer-implemented software activity of discovery, identification, connectivity, and updating current identifiers of the repeater box. In the screen shot in the lower center of FIG. 12 is representational of the computer-implemented software activity entitled trusses, the user manages the over-head lifting elements/structures and pairs the element with a repeater box for future ease of connectivity and bi-directional communication with the computer readable software. The bi-directional communication comprises adding, editing, deleting, estimating, and displaying all activities related to the selected element/structure. In the next screen shot to the right is representational of the computer-implemented software activity entitled Planning. All computer-implemented activities related to load estimating of a representational cross-section of commonly implemented equipment comprising manufacturer specific data through convenient pull-down menus. FIG. 12 further comprises the representational screen shot in the lower right-hand corner is the computer-implemented software activity entitled Monitoring. This representational page provides the user with resultants of the queries, including but not limited to the previously queried load estimation with a total, the current or saved data packet readings from the strain gage(s) with a total, and the display of peak loads observed by the active data packets received from the strain gage(s). The representational screen shot of Monitoring further comprises the ability of a computer-implemented activity of updating the corresponding size strain gage (s) on a per channel priority. At the top of the representational screen shot are two features for the computer-implemented activities of “wink” and “connect/disconnect”. First, the previously described activity of the “wink” icon allows the user to identify the repeater the computer readable medium software is currently connected to in bi-directional communication. The second activity is the “connect/disconnect” icon which allows the user to select active or non-active bi-directional communication with the enabled repeater.

1. The computer-implemented method comprises the ability to document the over-head lifting project to be performed by the user. Wherein, the project is defined by the user.

2. The computer-implemented method of claim 1 further comprises the ability to document the different elements/structures to be lifted. Wherein, the user defines the element/equipment to be evaluated for safe over-head lifting.

3. The computer-implemented method of claim 1 further comprises the ability to add type and quantity of element/equipment to be attached to the element/structure to be lifted. Wherein, the user selects the element/equipment from a predetermined menu of options, and then defines the quantity of each element/equipment.

4. The computer-implemented method of claim 1 further comprises the ability to total the estimated measurement of the element/structure to be lifted. Wherein, the method processes the data packet generated in claim 3 to display a set of variables for the user to evaluate the quantity of attachment points and proper load rated lifting devices to be used during the over-head lifting practice.

5. The computer-implemented method comprises the ability to calculate length of material needed to locate placement of the attachment point on the element/structure to the architectural structure. Wherein, the user defines the set of variables and final coordinates of the attachment point in relation to the architectural structure.

6. The computer-implemented method of claim 5 further comprises the ability to calculate the tension transferred to the architectural structure. Wherein, the user defines the weight generated by the attachment point and calculates the force to be transferred to the architectural structure.

7. The computer-implemented method comprises the ability to receive data packets from force monitoring transducers. Wherein, force monitoring transducers are installed to the attachments points of the element/structure or the attachment point of the architectural structure to measure the force being exerted. The resultant data packets sent by the force monitoring transducers are processed and presented for real time evaluation by the user.

8. The computer-implemented method of claim 7 further comprises the ability to record and store peak load data packets. Wherein, the peak load is monitored and record until a higher peak load is processed.

9. The computer-implemented method of claim 7 further comprises the ability to export stored data packets. Wherein, the exportation of data packets allow for data base operations and reporting history of load monitoring activities.

10. A load monitoring system comprising: a transducer; a power supply; a processor; a data bus coupled to the processor; a memory coupled to the data bus; a network broadcasting processor and antennae; and a computer-usable medium embodying computer program code, the computer program code comprising instructions executable by the processor and configured for: receiving a request by the user to receive a report contained in a data packet regarding the forces being exerted at the attachment points of an element/structure during over-head lifting operations.

11. The system of claim 10, wherein a strain gage (transducer) is used to collect data of the forces involved with the over-head lifting operation. Wherein, a strain gage is placed in the line of force produced by the attachment of an element/structure to an architectural structure for over-head lifting operations to produce an electrical signal of the real time force being exerted.

12. The system of claim 10, wherein instructions further comprise executable instructions for: receiving data packets from force monitoring transducers. Wherein, force monitoring transducers are installed to the attachment point (s) of the element/structure or the attachment point (s) of the architectural structure to measure the force being exerted. The resultant data packets sent by the force monitoring transducers are processed and presented for real time evaluation by the user.

13. The system of claim 10, wherein a repeater is the enclosure device for the comprising power supply; processor; data bus coupled to the processor; memory coupled to the data bus; network broadcasting processor and antennae.

14. The system of claim 10, wherein the computer program code comprising instructions executable by the processor and configured for: sending a request by the user to update repeater identifier, otherwise known as “friendly name”.

15. The system of claim 10, wherein the computer program code comprising instructions executable by the processor and configured for: sending a request by the user to identify repeater, otherwise known as “wink”.

16. A computer-readable medium encoded with a computer program, the computer program comprising computer executable instructions configured for: receiving a request from the user and delivering data packets for evaluation by the user.
